(19) United States
(12) Patent Application Publication
(10) Pub. No.: US 2026/0079092 A1
(43) Pub. Date: Mar. 19, 2026

(54) Underwater Global Luminescent Oil-Film (UGLOF) Skin Friction Meter

(71) Applicant: Board of Trustees of Western Michigan University, Kalamazoo, MI (US)

(72) Inventors: David Moussa Salazar, Kalamazoo, MI (US); Parviz Merati, Kalamazoo, MI (US); Tianshu Liu, Portage, MI (US); Brian Montgomery, Kalamazoo, MI (US)

(21) Appl. No.: 19/329,537

(22) Filed: Sep. 15, 2025

Related U.S. Application Data
(60) Provisional application No. 63/694,593, filed on Sep. 13, 2024.

(51) Int. Cl. G01N 13/02; G01N 21/33

(52) U.S. Cl. CPC G01N 13/02; G01N 21/33; G01N 2013/0216

(57) ABSTRACT

Aspects of the present disclosure may include methods for assessing high resolution skin friction fields generated by at water moving across at least a portion of an object surface, the method including covering the at least a portion of an object surface with a layer of oil film comprising a luminescent dye; placing the object in moving water; assessing the luminescence of the dye in at least two consecutive time periods, wherein the luminescence of the dye is related to the thickness of the oil film at one or more locations on the surface of the object.

### CROSS REFERENCE TO RELATED APPLICATIONS

The present application claims priority to U.S. Provisional Application No. 63/694,593, filed Sep. 13, 2024, the contents of which are incorporated by reference in their entirety.

### BACKGROUND OF THE INVENTION

The following disclosure describes aspects and embodiments an underwater global luminescent oil-film (UGLOF) skin friction meter for the extraction of high resolution skin friction fields from underwater measurements. The UGLOF skin friction meter was developed for the extraction of skin friction fields from luminescent oil images by using the relationship between the thickness and the luminescent intensity of a thin oil-film doped with a luminescent dye. By using the thin-oil film equation, which provides the relation between skin friction and oil-film thickness, an approximation Euler-Lagrange equation can be derived using a variational formulation which can be then numerically solved to extract a snapshot solution of the skin friction field from two consecutive luminescent oil images. Using a superposition scheme, the spatial-temporal evolution history of the oil film can be reconstructed.

To demonstrate the effectiveness of the proposed technique, skin friction measurements were performed on a 65° delta wing at a 10° angle of attack (AoA) using Western Michigan University's water channel at the Fluid Mechanics Laboratory. Furthermore, for comparison purposes, skin friction measurements were performed on the same model using the low-speed wind tunnel at WMU's Applied Aerodynamics Laboratory. Both tests were performed at the same chord-based Reynolds number. From the results obtained, underwater and wind tunnel tests were found to be in agreement topologically speaking. Both results showed separation and reattachment lines, which are consistent with delta wings flow structures. Based on these results, the UGLOF technique has great potential as the only technique currently available for underwater global skin friction measurements.

### SUMMARY OF THE INVENTION

Aspects of the present disclosure may include methods for assessing high resolution skin friction fields generated by at water moving across at least a portion of an object surface, the method including covering the at least a portion of an object surface with a layer of oil film comprising a luminescent dye; placing the object in moving water; assessing the luminescence of the dye in at least two consecutive time periods, wherein the luminescence of the dye is related to the thickness of the oil film at one or more locations on the surface of the object.

In other aspects, the luminescence of the oil film may be assessed using UV light. In yet other aspects, the method may further includes assessing the skin friction of the portion of the object under water by using the relationship between skin friction and oil-film thickness. In others, aspects may include obtaining an image of the oil luminescence of the portion of the object under water at one or more times.

In yet other aspects, the method may include calculating the overall oil-film thickness from the image of the oil luminescence, and assessing the skin friction of the portion of the object under water by using the relationship between skin friction and oil-film thickness.

In yet others, the method may include extracting a snapshot solution of the skin friction field from two consecutive luminescent oil images. In others, the moving water has a velocity of about 0.3 m/s or less. In yet others, the oil has a viscosity of about 80 cSt. In others, the luminescent dye is oil-based and luminesces upon radiation with UV light.

Embodiments of the present disclosure may include a system for assessing high resolution skin friction fields generated by at water moving across at least a portion of an object surface, the system comprising an oil film comprising a luminescent dye, wherein the oil film is capable of being uniformly spread in a thin film across an object surface, wherein the oil film comprising a luminescent dye is capable of differential luminescence based on oil-film thickness; a water channel capable of moving water at a uniform velocity; an acquisition device to acquire luminescence data; and a light source capable of causing the luminescent dye to luminesce.

In some embodiments and aspects, the acquisition device may be any device capable of sensing and locating differences in luminescence intensity. In some, the device may be a digital camera. In others, image and/or light intensity and location data may be further processed using a data processor (i.e., a general computer or special purpose device) to compute relationships between light intensity, oil thickness, and skin friction as described more fully below.

In some embodiments, the light source emits UV light. In others, the acquisition device is a digital camera. In yet others, the digital camera can obtain two or more consecutive luminescent oil images to assess changes in luminescence over time. In yet others, the moving water has a velocity of about 0.3 m/s or less. In others, the oil has a viscosity of about 80 cSt. In yet others, the luminescent dye is oil-based and luminesces upon radiation with UV light.

### DESCRIPTION OF THE DRAWINGS

FIG. 1 depicts a water tunnel in the Fluid Mechanics Laboratory at Western Michigan University used in aspects and embodiments of the present disclosure;

FIG. 2 depicts a schematic diagram of testing setup for an example aspect and embodiment of UGLOF skin friction measurements;

FIG. 3 shows a delta wing model with luminescent oil-film underwater during testing using an example aspect and embodiment of the present disclosure;

FIG. 4 is a schematic diagram for skin friction measurements in a wind tunnel for comparison;

FIG. 5 shows sample oil-film images for: (left) underwater, and (right) wind tunnel produced using example aspects and embodiments of the present invention;

FIG. 6 shows normalized skin friction magnitude fields for (left) underwater, and (right) wind tunnel produced using example aspects and embodiments of the present invention;

FIG. 7 shows skin friction lines for: (left) underwater, and (right) wind tunnel produced using example aspects and embodiments of the present invention;

FIG. 8 are graphs of skin friction profile (spanwise) comparison at x/c=0.3 (top) 0.6 (middle) and 0.9 (bottom).

### DETAILED DESCRIPTION OF THE INVENTION

Generally speaking, skin friction is often regarded as one of the most crucial surface quantities needed to fully understand flow behavior, specially, near-wall structures in complex flows. Nevertheless, despite its significance, along with surface pressure and temperature, it is also recognized as one of the most challenging quantities to assess experimentally speaking (Liu et al. 2008; Liu 2019; Woodiga and Liu 2009), especially in underwater measurements. In the past, numerous local and global skin friction techniques have been developed for air-based Measurements (Aguiar-Ferreira et al. 2018; Boiko and Kornilov 2010; Crafton et al 2008; Goss et al. 2019; Lee et al. 2018), however, as of right now, none of these techniques have been successfully applied for underwater measurements. Therefore, the following document describes the development of an underwater skin friction meter.

Aspects and embodiments presented in this disclosure were developed using the relationship between the thickness and the luminescent intensity of a thin oil-film doped with a luminescent dye. The change on the thickness of a thin oil-film on a solid surface is related to the skin friction, pressure gradient, gravitational acceleration and surface tension as given in the thin-oil-film equation (Liu et al. 2008; Brown and Naughton 1999), i.e.

$$\frac{\partial h}{\partial t} + \frac{\partial }{\partial {X}_{i}} ( \frac{{h}^{2}}{2 μ} {τ}_{i} - ( \frac{\partial {P}_{o}}{\partial {X}_{i}} - ρ {g}_{i} ) \frac{{h}^{3}}{2 μ} ) = 0 ( i - 1 , 2 ) \qquad ( 1 )$$

where h is the thickness of the oil-film, τᵢ is the skin friction vector, μ is the dynamic oil viscosity, ρ is the oil density, gᵢ is the gravitational acceleration vector, and Xᵢ are the corresponding object space coordinates on the surface plane. The pressure at the oil-film, Pₒ, is given by Pₒ≈pₐ+σ∀²h, where pₐ is the air pressure and σ is the surface tension of the oil (Liu et al. 2008).

The thickness of the oil-film is proportional to the luminescent intensity as given by I=aIₑₓh, where α is a coefficient proportional to the quantum efficiency of the seeded molecules and dye concentration and I and Iₑₓ are the image intensity and the intensity of the excitation light on the surface, respectively (Liu et al. 2008; Liu 2019). Using image projection transformation, Eq. (1) can be written in the image plane, i.e.,

$$\frac{\partial g}{\partial t} + ∇ \cdot ( g \overline{τ} ) = f \qquad ( 2 )$$

where g=I/Iex is the normalized luminescent intensity, ∀=∂/∂xi is the gradient operator, and τ−=τg(λ/2μα) is the equivalent skin friction where λ is the scaling constant for image projection and it is considered a constant (Liu et al. 2008). The effects of pressure gradient ∂p/∂xi and the gravitational vector gi are given by

$$f = λ \frac{\partial }{\partial {X}_{i}} ( λ ( \frac{\partial {P}_{o}}{\partial {X}_{i}} - ρ {g}_{i} ) \frac{{g}^{3}}{3 μ {a}^{2}} ) \qquad ( 3 )$$

For a thin oil-film (h<<1), the effects of the pressure gradient, gravity and surface tension can be neglected as higher-order small terms such that the first-order approximation is f=0.

Since Eq. (2) has the same mathematical form as the physics-based optical flow equation, the equivalent skin friction field τ− can be obtained using the same variational solution for optical-flow computation which is constrained by a smoothness regularization term (Liu et al. 2008; Liu 2019). The Euler-Lagrange equation for τ− is given by

$$g ∇ [ \frac{\partial g}{\partial t} + ∇ \cdot ( g \overline{τ} ) - f ] + α {∇}^{2} \overline{τ} = 0 \qquad ( 4 )$$

where the Neumann condition, ∂t/∂n=0, is applied on the domain boundary and ox is the Lagrange multiplier.

Using two successive UGLOF images, the Euler-Lagrange equation Eq. (4) is solved numerically by using a standard finite difference method to obtain a snapshot field of τ−. In order to reconstruct a complete steady-state skin friction field, a superposition scheme is used to reconstruct a τ− field from a sequence of snapshot solutions to incorporate the spatial-temporal evolution history of the oil-film (Liu et al. 2008). Without calibration, this approach provides a relative or normalized skin friction field. To determine the unknown proportional coefficient in the relative skin friction field, in situ calibration or other reliable experimental, computational and theoretical methods are required to obtain some accurate values of skin friction at several locations. For the purpose of the examples below, normalized skin friction fields are presented without a priori or in situ calibration.

Error Analysis. To evaluate the error propagation associated with the variational formulation used in the derivation of Eq. (4), g and τ are decomposed into (Liu et al. 2008; Liu 2019):

$$g = {g}_{o} + δ g \qquad ( 5 a )$$

$$τ = {τ}_{o} + δ τ \qquad ( 5 b )$$

where δg and δτ are the errors, and the subscript “0” denotes the non-perturbed fields that exactly satisfy Eq. (4). Substitution of Eqs. (5a)-(5b) into Eq. (4) and neglecting the higher-order small terms results in the following error propagation equation (Liu et al. 2008; Liu 2019):

$$( δτ \cdot ∇ {g}_{o} ) ∇ {g}_{o} - α {∇}^{2} δτ = - ( \partial δ g / \partial t + {τ}_{o} \cdot ∇ δ g ) ∇ {g}_{o} \qquad ( 6 )$$

where δg directly contributes to δτ through a time operator and δg contributes to δt through a gradient operator projected on the skin friction vector.

Furthermore, for a local region where ∀go=const. And |∀go| is defined as the magnitude of ∀go, the normal unit vector to an iso-line is given by NT=∀go/|∀go|. In this case, the skin friction error δτ projected on NT is (δτ)N=δτ·NT. Normalization of Eq. (6) results in the relative error propagation equation given by Liu et al. (2008); Liu (2019):

$$\frac{{( δτ )}_{N}}{‖ {τ}_{o} ‖} - \frac{\partial δ g / \partial t}{‖ ∇ {g}_{o} ‖ ‖ {τ}_{o} ‖} - \frac{{τ}_{o}}{‖ {τ}_{o} ‖} \cdot δ {N}_{T} + \frac{α}{{‖ ∇ {g}_{o} ‖}^{2}} {∇}^{2} [ \frac{{( δτ )}_{N}}{‖ {τ}_{o} ‖} ] \qquad ( 7 )$$

In Eq. (7), it is assumed that ∀ and δ are interchangeable. The first term in the right hand side represents the contribution from the elemental error in measurement of ∂δg/∂t. The second term describes the contribution from the elemental error in measurement of the intensity gradient. The third term is the error associated with the Lagrange multiplier from the artificial diffusion of the error (δτ)N. As shown in Eq. (7), the first and third terms are proportional to |∀go|−1 and |∀go|−2, respectively. This indicates that the relative error will be very large when |∀go| approaches zero, which imposes an intrinsic limitation on application of this technique in regions where |∀go| is close to zero. Furthermore, in the third term, the Lagrange multiplier a must be sufficiently small to reduce the error particularly when |∀go| is small. Otherwise, the error of the regularized solution could be large in these regions.

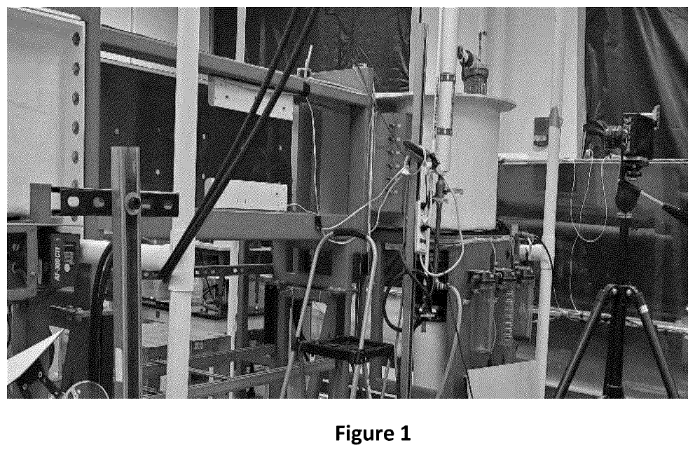

Example 1. To demonstrate the effectiveness of the UGLOF technique, experiments were conducted in a water channel (The Rolling Hills Research Corporation; Model 1520) located in the Fluid Mechanics Laboratory at Western Michigan University. The water channel has a test section 380 mm wide, 510 mm high, and 1,520 mm long with a free water surface on the top which provides simple access to the test model and easy setup. The test section has tempered glass on the side and bottom sections, allowing optical access during testing. The channel is operated as a continuous flow and the test section flow velocity can be adjusted, with a maximum velocity of 0.3 m/s. In the test section, the turbulence intensity is less than 0.1%. and the velocity nonuniformity is less than 2%. FIG. 1 is a photograph of the water channel apparatus used.

In this study, measurements were performed on a 65° delta wing. The span s and chord c of the model were 150 mm and 175 mm, respectively. Skin friction measurements on the model were conducted at an angle of attack (AoA) of 10° and a free stream velocity of 0.3 m/s, corresponding to a chord-based Reynolds number of 5.89×10⁴. The luminescent oil mixture used was made with an oil-based UV dye (Petroleum Tracer Concentrate DFSB-K175 from Risk Reactor) and a silicon-based oil with a viscosity of 80 cSt. To enhance the contrast of the oil-film, the model was coated with white Mylar. Before testing, the luminescent oil was brushed carefully onto a model surface using a foam brush in order to ensure a uniform oil-film application.

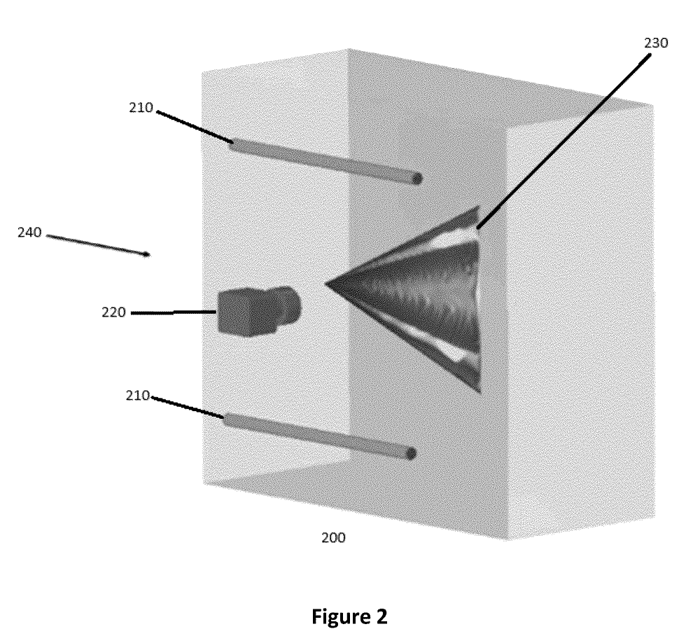

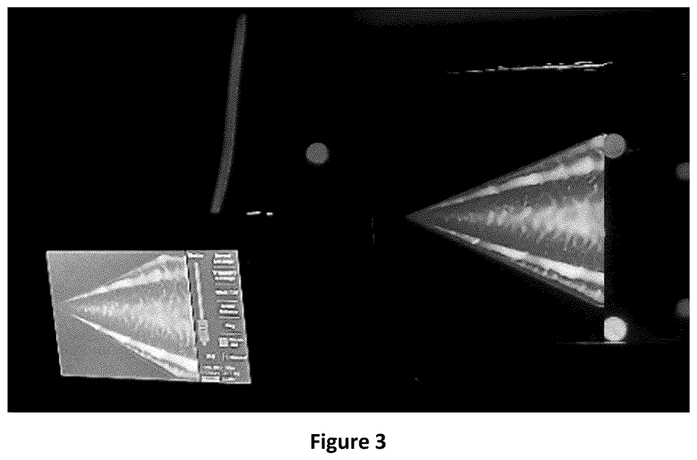

The resulting luminescent oil emitted the radiation at a longer wavelength (about 550-620 nm) when excited by UV illumination. Two UV lamps were positioned on the side of the optical access of the test section to ensure uniform illumination. A long-pass filter (>550 nm) was used for the detection of the luminescent emission centered at approximately 590 nm. During testing, the water channel was run in a dark environment, and images were captured using Basler CCD camera at 2 frames per second with a resolution of 800×700 pixels. During processing, a total of 150 snapshot solutions were used to reconstruct the complete skin friction field. A schematic diagram of the experimental setup is shown in FIG. 2. Test setup 200 contains one or more UV lights 210, one or more cameras 220, the tested object 230 (here the delta wing), and the direction of fluid flow is shown by arrow 240. The actual test model during testing with the oil film under UV excitation is shown in FIG. 3.

Example 2. For comparison purposes, skin friction measurements were performed on the same test model using the low-speed wind tunnel at the Applied Aerodynamics Laboratory of Western Michigan University, where the test section is 405 mm by 405 mm. The wind tunnel free stream velocity ranges from 5 to 50 m/s and the freestream turbulence intensity is about 0.2%. Clear windows on the top and side of the test section allow visual access during testing. The model was tested at the same 10° angle of attack but at a free stream velocity of 6 m/s corresponding to the same chord-based Reynolds number of 5.89×10⁴.

From an experimental standpoint, the setup used was very similar to the one used for underwater measurements. Two UV lights were placed on top of the test section to provide uniform illumination of the oil-film during the test. The same CCD camera was also placed on top of the test section to record the oil-film evolution. However, a major difference during the wind tunnel test was the oil viscosity. Due to the larger shear forces on the wind tunnel (compared to the water channel), the oil viscosity was increased to 250 cSt. This change was made in order to increase the time required to obtain a fully developed oil-film. Furthermore, the image acquisition frame rate was also adjusted to 10 frames per second, with a resolution of 800×700 pixels. During processing, a total of 150 snapshot solutions were also used to reconstruct the complete skin friction field.

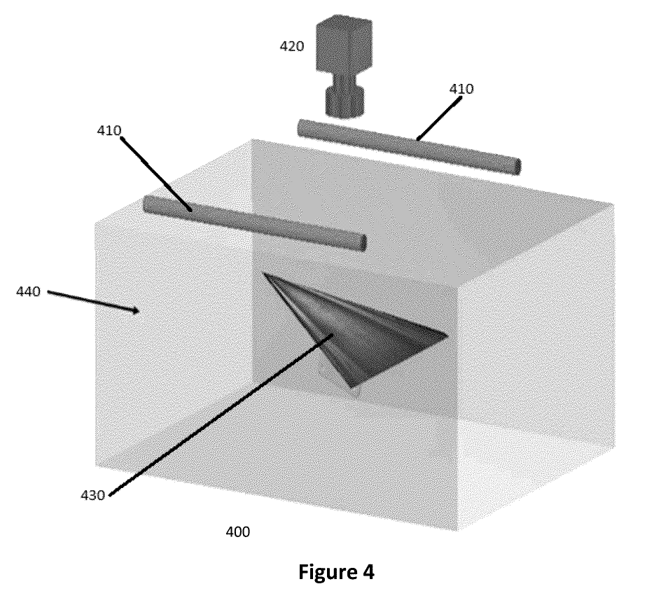

FIG. 4 shows the schematic diagram for skin friction measurements on the low-speed wind tunnel 400, which included one or more UV lights 410, and one or more cameras 420. The tested object 430 (here the delta wing of Example 1) is placed in the tunnel 400, with the direction of wind flow shown by arrow 440.

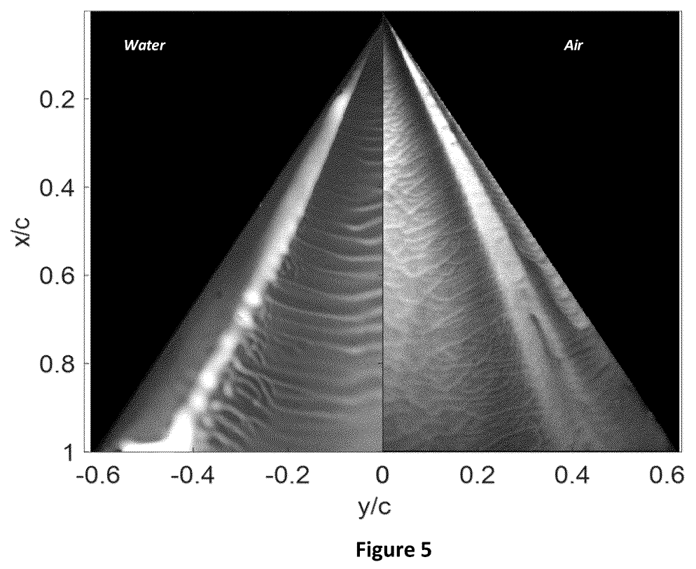

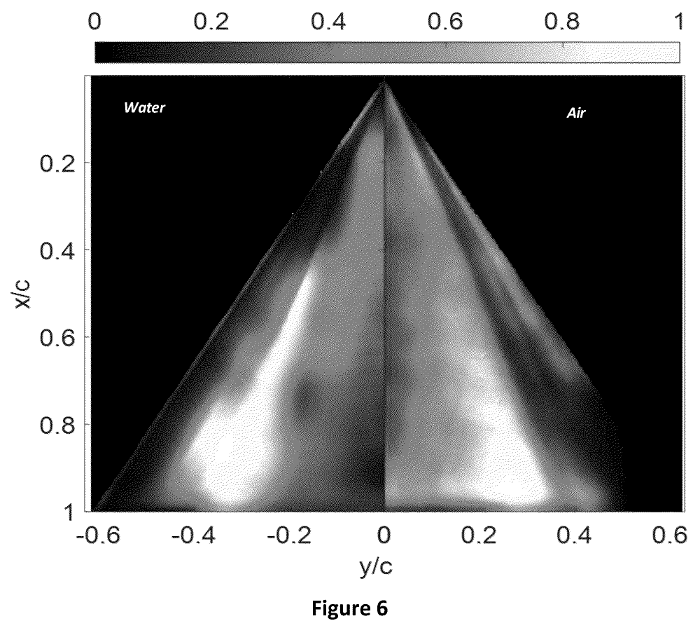

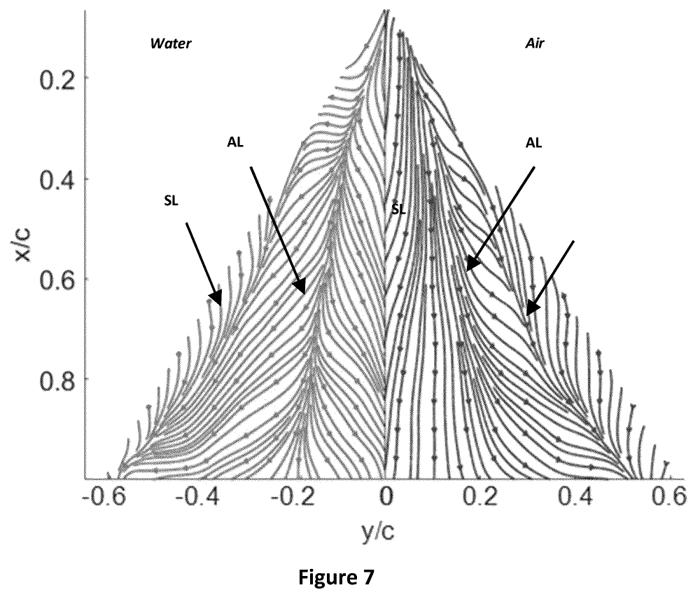

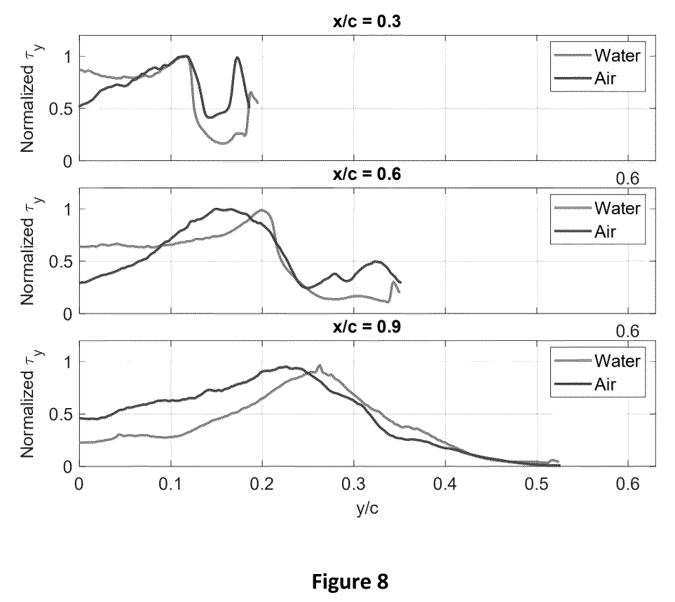

Example 3. Using the procedure described in Section 2, global skin friction data was extracted from the underwater as well as the wind tunnel test performed on the delta wing model. This example provides a direct comparison of the results obtained from both tests. In the results shown, coordinates are normalized by chord length c with the x-axis on the streamwise direction and the y-axis on the spanwise direction. FIG. 5 shows a comparison of the fully developed oil-films for water (left) and air (right) testing. FIG. 6 shows a comparison of the normalized skin friction magnitudes for water (left) and air (right) testing. Here, skin friction fields are normalized by their corresponding absolute maximum value. FIG. 7 shows a comparison of the skin friction lines for water (left) and air (right) testing. Lastly, FIG. 8 shows a comparison of the skin friction profiles (in the spanwise direction) at three different streamwise locations (x/c=0.3, 0.6, and 0.9) for water and air testing.

As shown in FIGS. 6-8, the results obtained from both underwater and wind tunnel tests are consistent. Especially when looking at the skin friction lines, both results show essentially the same topological skin friction results. In both cases, separation (SL) and attachment (AL) lines are visible at the same locations. Here, an attachment line is a skin friction line from which neighboring skin frictions diverge, while a separation line is a skin friction line to which neighboring skin friction lines converge.

In this important to mentioned, that even though the chord-based Reynolds number was matched in both tests for comparison purposes (by adjusting free stream velocity), flow properties (i.e., density, dynamic and kinematic viscosities) remained different in each test. Therefore, in this work, the results obtained from the wind tunnel are simply used to evaluate topological structures (i.e., SL and AL locations) rather than to perform a quantitative comparison.

From an experimental point of view, skin friction is generally considered one of the most difficult quantities to measure in fluid mechanics, however, in order to obtain a better understanding of fluid flow behavior, the ability to accurately measure global skin friction is critical. For air-based measurements (i.e. wind tunnel testing), numerous local and global skin friction techniques have been developed throughout the years. However, for underwater measurements there is currently no technique capable of accurately measure skin friction (neither local nor global). Therefore, developing a technique capable of providing underwater skin friction topological data represents a breakthrough in experimental fluid mechanics.

The present disclosure describes the working principle of the UGLOF skin friction meter starting from the relationship between oil-film thickness and skin friction through the thin oil-film equation, all the way to the Euler-Lagrange equation derived in order to obtain a snapshot skin friction field. Combining this with a superposition scheme, the complete spatiotemporal skin friction evolution can be reconstructed. The errors associated with the variational formulation used to derive the Euler-Lagrange equation are also noted.

Finally, skin friction measurements are carried out on a 65° delta wing. For comparison, skin friction measurements were performed on the same model using a low-speed wind tunnel at the same Reynolds number. From the results obtained, the UGLOF skin friction meter shows consistent skin friction topological structures (mainly separation and attachment lines), which are known to be present in delta wings flow structures.

1. A method for assessing high resolution skin friction fields generated by at water moving across at least a portion of an object surface, the method comprising
covering the at least a portion of an object surface with a layer of oil film comprising a luminescent dye;
placing the object in moving water;
assessing the luminescence of the dye in at least two consecutive time periods,
wherein the luminescence of the dye is related to the thickness of the oil film at one or more locations on the surface of the object.

2. The method of claim 1, wherein the luminescence of the oil film is assessed using UV light.

3. The method of claim 1, further comprising
assessing the skin friction of the portion of the object under water by using the relationship between skin friction and oil-film thickness.

4. The method of claim 1, further comprising obtaining an image of the oil luminescence of the portion of the object under water at one or more times.

5. The method of claim 4, further comprising
calculating the overall oil-film thickness from the image of the oil luminescence, and
assessing the skin friction of the portion of the object under water by using the relationship between skin friction and oil-film thickness.

6. The method of claim 5, further comprising
extracting a snapshot solution of the skin friction field from two consecutive luminescent oil images

7. The method of claim 1, where the moving water has a velocity of about 0.3 m/s or less.

8. The method of claim 1, where the oil has a viscosity of about 80 cSt.

9. The method of claim 1, where the luminescent dye is oil-based and luminesces upon radiation with UV light.

10. A system for assessing high resolution skin friction fields generated by at water moving
across at least a portion of an object surface, the system comprising:
an oil film comprising a luminescent dye, wherein the oil film is capable of being uniformly spread in a thin film across an object surface, wherein the oil film comprising a luminescent dye is capable of differential luminescence based on oil-film thickness;
a water channel capable of moving water at a uniform velocity;
an acquisition device to acquire luminescence data; and
a light source capable of causing the luminescent dye to luminesce.

11. The system of claim 10, wherein the light source emits UV light.

12. The system of claim 10, wherein the acquisition device is a digital camera.

13. The system of claim 12, wherein the digital camera can obtain two or more consecutive luminescent oil images to assess changes in luminescence over time.

14. The system of claim 10, where the moving water has a velocity of about 0.3 m/s or less.

15. The system of claim 10, where the oil has a viscosity of about 80 cSt.

16. The system of claim 11, where the luminescent dye is oil-based and luminesces upon radiation with UV light.
